(19) United States
(12) Patent Application Publication
(10) Pub. No.: US 2005/0138402 A1
(43) Pub. Date: Jun. 23, 2005

(54) Methods and apparatus for hierarchical system validation

(76) Inventors: Jeonghee M. Yoon, Portland, OR (US); David M. Durham, Hillsboro, OR (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/744,990

(22) Filed: Dec. 23, 2003

(51) Int. Cl. H04L 9/32

(52) U.S. Cl. 713/193

(57) ABSTRACT

A data security system includes a memory, a security tool stored within the memory and a validation agent stored within the memory. A first processor is operatively coupled to the memory and programmed to use the security tool to prevent unauthorized access to the memory and programmed to use the validation agent to monitor the integrity of the security tool. A second processor is programmed to directly access the memory and to monitor the integrity of the validation agent. A data bus is operatively coupled to the first and second processors and arranged to allow the second processor to directly access the validation agent. If the validation agent is compromised, the second processor causes the first processor to communicatively decouple from a network. If the security tool is compromised, the second processor causes the first processor to decouple from a network.

### FIELD OF THE TECHNOLOGY

This patent is directed to computer security, and, more particularly, to monitoring and validating the integrity of software components on a computer.

### BACKGROUND

In computer networking, computers and network systems security is becoming increasingly important. In some cases, security breaches may cause a great deal of damage in terms of computer down time, data loss, data theft, financial implications, etc. Various technologies, such as firewall software, data encryption, identification verification, and other security tools, have been developed to protect computers and network systems from security breaches. Although designed to provide security, these protective measures themselves are susceptible to attacks and may be compromised by those who possess sufficient knowledge about the technology being used. For example, network firewall software may be used to protect a computer from unauthorized access to and from a network. However, a technologically savvy user or rogue software may easily disable the firewall, or other security tool, or change its configurations to allow unauthorized access to network resources. In general, any software that runs on a computer may be susceptible to compromises if a person is determined to circumvent the security tool and gain access to the computer.

Methods have been developed that provide integrity monitoring and validation services of security tools, such as personal firewalls or other protective measures that provide security for a particular system. For example, security software, commonly referred to as intrusion detection systems (IDS), monitors and validates the code and configuration of the various security components. Intrusion detection systems have been known to reside on a host and be executed by a host processor. The host processor also executes the security tools, the operating system and other applications. As such, the intrusion detection system software may be susceptible to the same kind of attacks as the security tools it protects, because the IDS runs on the same processor as the security tools. A technologically knowledgeable attacker may first disable the intrusion detection system, and then attack the security software protected by the intrusion detection system.

An example of such an intrusion detection system is known as tripwire. Tripwire monitors the integrity of other security tools, such as firewalls and anti-virus scanners, by monitoring the binary files and configuration files for tampering. In particular, tripwire monitors the physical files stored on a storage device on the host. Both tripwire and the security tools are executed on the same host, and, as a result, tripwire is subject to the same kind of tampering as the software being monitored.

### BRIEF DESCRIPTION OF THE DRAWINGS

FIG. 1 is a bock diagram of an example of a computer security system;

FIG. 2 is a block diagram of an example of a client and network interface controller shown schematically in FIG. 1;

FIG. 3 is a flowchart of an example of a validation routine that may be performed by a validation core located on the network interface controller; and

FIG. 4 is a flowchart of an example of a validation routine that may be performed by a validation agent located on the client.

### DETAILED DESCRIPTION OF THE EXAMPLES

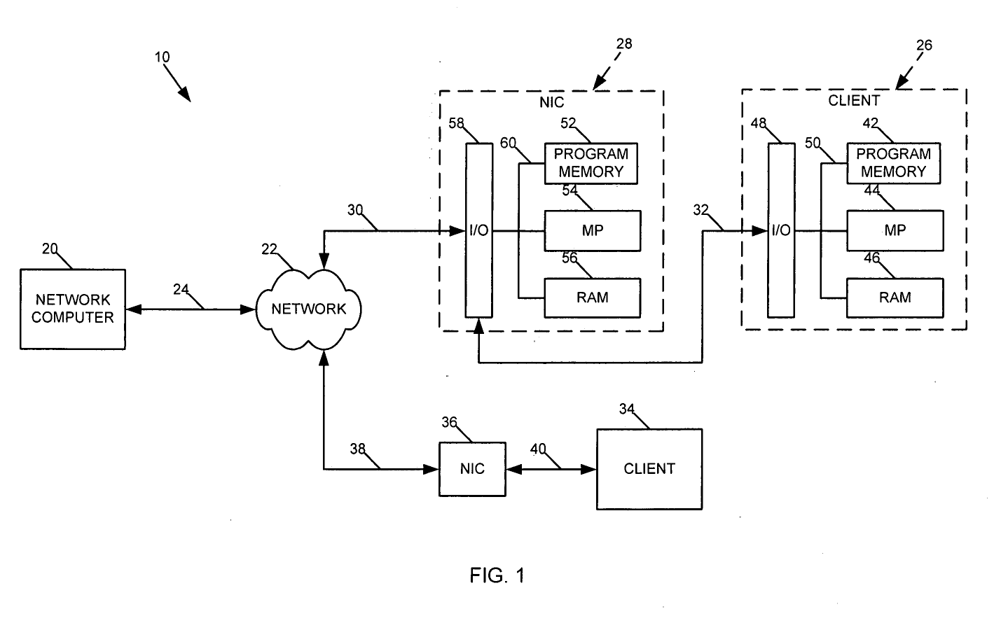

An example of a computer security system 10 is shown generally in FIG. 1. Although the computer security system 10 is particularly well suited for security on an open network, such as the Internet, or the like, persons of ordinary skill in the art may readily appreciate that the teachings of the instant invention are not limited to any particular type of network or computer system. On the contrary, the teachings of the invention may be employed with virtually any computer system or network where data security is desired. Thus, although the computer security system 10 will be described below primarily in relation to a host computer operatively coupled to an open network, persons of ordinary skill in the art will readily appreciate that the apparatus and method could likewise be used with any type of network, computer system, network server, local area network (LAN), network device, etc.

Generally, the computer security system 10 includes a network computer or server computer 20 operatively coupled to a network 22 via a network data link or bus 24. The computer security system 10 may further include a client or host 26 operatively coupled to the network 22 via a network interface controller (NIC) interface 28 and network data link or bus 30. The client 26 may be coupled to the network controller 28 via a data link or bus 32. A second client or host 34 may likewise be operatively coupled to the network 22 via a network interface controller 36 and network data link or bus 38, whereby the client 34 is operatively coupled to the network controller 36 via data link or bus 40. The network 22 may comprise, for example, the Internet, a wide area network (WAN), a local area network (LAN), or any other network where data security is desired. Where the network 22 comprises the Internet, data communication may take place over data links 24, 30, 38, which may be provided as communication links, via an internet communication protocol.

The network computer 20 may be provided in a first location, and the client 26 and network interface controller 28 may be provided in a separate geographic location than the network computer 20. Likewise, the client 34 and network controller 36 may be provided in a separate geographic location from the client 26 and network interface controller 28 and/or the network computer 20. The network security system 10 may include a plurality of network computers or server computers, each of which may be operatively interconnected. Although the computer security system 10 is shown to include one network computer 20, two clients 26, 34, and two network interface controllers 28, 36, it should be understood that different numbers of computers, clients and network interface controllers may be utilized. For example, the computer security system 10 may include a plurality of network computers 20 and tens or hundreds of clients 26, all of which may be interconnected via the network 22. The data links 24, 30, 32, 38, 40 may be provided as dedicated hardwired links and/or as wireless links. Although the data links 24, 30, 32, 38, 40 are shown as single data links, the data links 24, 30, 32, 38, 40 may each comprise multiple data links. As seen in FIG. 1, the client 26 may comprise a program memory 42, a microcontroller or microprocessor (MP) 44, a random access memory (RAM) 46 and an input output (I/O) circuit 48, all of which may be interconnected via an address/data bus 50. Likewise, the network interface controller 28 may be provided as an intelligent network interface controller which may comprise a program memory 52, a microcontroller or microprocessor 54, a random access memory 56 and an I/O circuit 58, all of which may be interconnected via an address/data bus 60.

It should be appreciated that although each client 26 or network interface controller 28 is shown with only one microprocessor 44, 54, each client 26 and/or network interface controller 28 may each include multiple microprocessors 44, 54. Similarly, the memories of the client 26 and network interface controller 28 may include multiple RAMs 46, 56 and multiple program memories 42, 52. Although the I/O circuits 48, 58, are shown as single blocks, it should be appreciated that each I/O circuit 48, 58 may include a number of different types of I/O circuits. The RAMs 46, 56 and program memories 42, 52 may be implemented as semiconductor memories, magnetically readable memories, and/or optically readable memories, for example. The program memories 42, 52 may be provided as read only memories (ROM), and/or as read/write or alterable memories, such as a hard disk. In the event a hard disk is used as the program memory 42, 52, the address/data buses 50, 60 shown schematically in FIG. 1 may each comprise multiple address/data buses, which may be of different types, and there may be an I/O circuit disposed between the various address/data buses. The data link or bus 32 operatively coupling the client 26 with the network controller 28 may comprise a bus that supports bus mastering capabilities, such as a peripheral component interconnect/interface (PCI) or another data bus that allows non-host based coprocessors that are operatively coupled to the bus 32 to access the client memory 42, 46 without the intervention or knowledge of the client microprocessor 44 (e.g., direct memory access). Although FIG. 1 discloses an intelligent network interface controller 28, additional intelligent devices (e.g., those comprising a non-host based microcontroller, microprocessor or coprocessor), such as LAN on motherboard (LOM), system chipsets or other peripheral devices, may also be operatively coupled to the bus 32.

In operation, the network computer 20 may collect information from each client 26 about the host software that needs to be validated. The host software may be any software to be validated, including, but not limited to, host-based security tools, such as firewalls, intrusion detection systems operating systems, applications, etc. Various other host-based security tools are well known to those of ordinary skill in the art and, thus, will not be described further herein. For the purposes of explaining the operation of the computer security system 10, the term “target” will be used to refer to host- based software or routine that will be validated.

The pieces of information collected about a target routine are packaged into a structure described herein as a “voucher.” A voucher may uniquely describe a target routine using a variety of methods, including, but not limited to, copies of all or part of the software (encrypted or unencrypted), configuration data, digital watermarks, digital signatures, checksum values, file size, cryptographic hash functions and/or results, or other unique characteristics regarding the software. The characteristics may relate to the data configuration of the target routine and/or the executable code of the target routine. The network computer 20 may configure each of the clients 26, 34 with the vouchers for the target routine to be validated. Each client 26, 34 may use this voucher to validate the target routine.

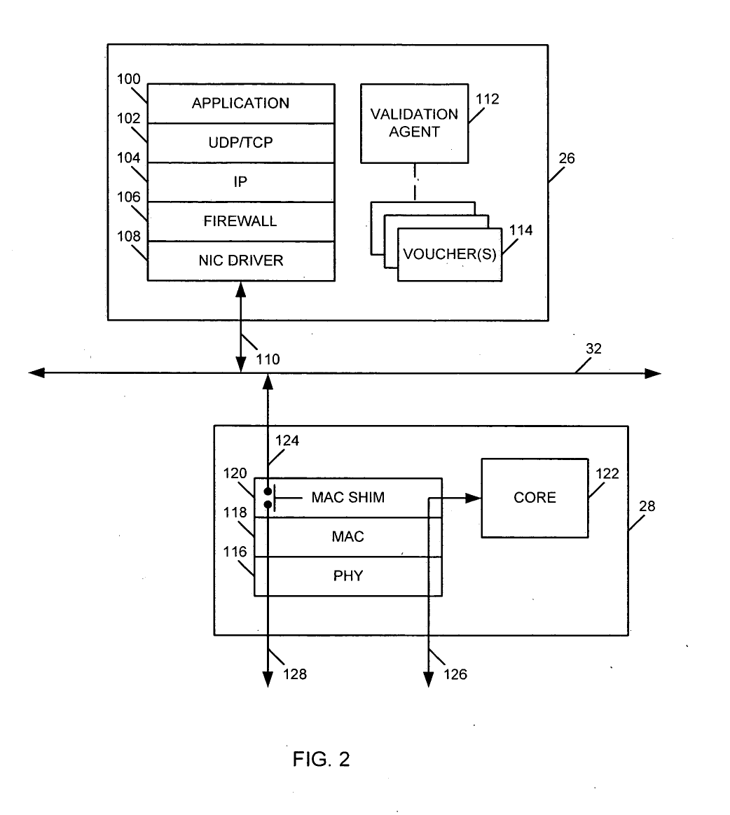

Referring to FIG. 2, an example of a client 26 and network interface controller 28, or other intelligent device, are provided. As explained above, the client 26 and the network interface controller 28 are operatively coupled to a data link or bus 32 having bus mastering capabilities, such as allowing the network interface controller 28 direct memory access to the client 26. The client 26 may include communication protocols, or protocol suites, implemented as hardware or software which may reside on a memory of the client 26. The communication protocols may be provided as various layers or levels of protocol, as may be found with various network architectures, including, but not limited to, open systems interconnect (OSI) or transmission control protocol/internet protocol (TCP/IP) which may be the bases for various communication protocols over the network 22, such as telnet, file transfer protocol, (FrP), user datagram protocol (UDP), reliable datagram protocol (RDP), etc. Those of ordinary skill in the art will recognize that various other communication protocols or protocol suites and/or various security tools 106 may likewise reside on the client 26.

As shown in FIG. 2, the various protocol layers may include an application protocol 100, such as dynamic host configuration protocol (DHCP), domain name system (DNS), file transfer protocol (FYP), hypertext transfer protocol (HTTP), interactive mail access protocol (IMAP), network file system (NFS), post office protocol (POP), simple mail transfer protocol (SMTP), telnet or various other application protocols, as are known to those of ordinary skill in the art, to provide network transparency, resource allocation, etc. A user datagram protocol (UDP) and transmission control protocol (TCP) may provide the session and transport layers for data transfer service between end points on the network 22. The UDP may provide data integrity, whereas the TCP may provide reliable transfer service. A network layer 104 may be provided by internet protocol (IP) to provide a delivery mechanism for packets of data being transferred across the network 22. As mentioned above, various security tools 106, such as firewall software, may be provided to protect against unauthorized access to the client 26. A device driver 108 may be operatively coupled to the bus 32 via a data link 110 to control the network interface controller 28.

The security tools 106 may be stored within a memory of the client 26 and executed by the microprocessor 44. During execution, a security tool 106, or other target routine, may undergo a paging operation. For example, when a target routine is loaded into the RAM 46 for execution, the client microprocessor 44 may cause the target routine to be divided into portions, or pages, which may be paged (e.g., switched) into and out of the memory 46 depending on which portions are being used or unused. This paging operation may be dictated by the operating system of the client 26, and may generally be performed when available memory is insufficient to accommodate the entire target routine. Portions that are not being used may be paged out of the memory to another physical memory device, such as a hard drive. In effect, the target routine may be fragmented into various portions which may not be contiguously maintained in the physical memory (i.e., the target routine may be paged).

When viewing the physical memory, the target routine may appear fragmented and noncontiguous. Although the physical memory may have sufficient available memory to maintain an unfragmented, contiguous view of a routine, this is not always guaranteed. Without viewing the unused portions or knowing how the portions coincide, a view of the physical memory alone may yield only an incomplete picture of the target routine. However, the operating system may still accommodate requests to allocate portions of the physical memory to provide unfragmented, contiguous views of a routine. In other words, the operating system may accommodate requests to suspend the paging operation for a routine.

The client 26 may maintain a table to track the location(s) of the various portions of the fragmented target routine. For example, the table may note the locations of the unused target routine portions located on a hard drive and the locations of the portions in the RAM 46. Because the client 26 may track the target routine pages, the client 26 may maintain a virtual memory of the target routine. The virtual memory may constantly provide an unfragmented, contiguous view of the target routine to the operating system and other routines executed by the client microprocessor 44. The physical and virtual memory views may therefore yield different views of the target software. However, operations or routines executed by another microprocessor or otherwise not executed by the client 26 may only have access to a physical view of the memory, and may not access the virtual memory.

A validation agent 112 may reside on a memory of the client 26 and be executed by the client microprocessor 44. The validation agent 112 may be provided as an intrusion detection system (IDS). The file size of the validation agent 112 may be small enough such that during execution the validation agent 112 may be completely located into the RAM 46. In turn, the RAM 46 may be provided with sufficient size to accommodate the entire validation agent 112. The validation agent 112 may also include instructions to avoid undergoing the paging process described above (i.e., the validation agent 112 may be non-paged). The client 26 or operating system may be requested to allocate physical memory portions for the validation agent 112 and suspend paging for the validation agent 112. In effect, both the virtual memory view and the physical memory view will provide an unfragmented, contiguous view of the validation agent 112.

Because the validation agent 112 may reside on the client 26 and be executed by the client microprocessor 44, the validation agent 112 may scan the virtual memory of the client 26 to view an unfragmented and contiguous version of the target routine. The validation agent 112 may validate the target routine, such as the security tool 106, by verifying the integrity of the target routine using an appropriate voucher 114 associated with the target routine. As mentioned above, the voucher 114 uniquely describes the target routine. Each voucher 114 may apply to a different target routine to be validated, and may reside on a memory of the client 26. For example, the voucher associated with the security tool 106 may uniquely identify a characteristic of the security tool 106, such as a code signature, code image, digital watermark, data image, checksum value, cryptographic hash function and hash result, etc. The validation agent 112 may compare the voucher 114 with the security tool 106 (or a characteristic thereof) to determine the integrity of the target routine (i.e., whether the target routine has been compromised by an unauthorized user).

Various communication protocols and/or protocol layers may reside on a memory of the network interface controller 28 or other intelligent device operatively coupled to the bus 32 and capable of accessing a memory of the client 26. The protocol layers may be executed by the processor 54 residing on the network interface controller 28. In the present example, the protocol layers may include a physical layer 116 (e.g., carrier sense multiple access/with collision detect (CSMA/CD), token ring, etc.) to provide electrical and mechanical connections to the network 22 for host-to-host communications. A data link layer may also be provided for data fragmentation and error checking. The data link layer may be provided as a media access control (MAC) sublayer 118 and as a logical link control (LLC) sublayer 120. The LLC sublayer 120 may be provided with a MAC Shim to gather statistics on data frames or data packets being transferred to and from the client 26, although the MAC Shim may be provided separate from the LLC sublayer. The MAC Shim 120 may further provide data packet routing among the network interface controller 28, the client 26 and a validation core 122.

The validation core 122 may be executed on the microprocessor 54, and be utilized to validate the validation agent 112 on the client 26 by directly accessing a run-time image of the validation agent 112, including the code data and configuration data of the validation agent 112 using bus mastering direct memory access via a data link 124. Because the validation core 122 does not reside on the client 26 and is not executed by the client microprocessor 44, the validation core 122 may only view the validation agent 112 as it appears in the physical memory, and may not have access to the virtual memory. However, because the validation agent 112 may be fully loaded in the physical memory without paging, the validation core 122 may be provided with an unfragmented, contiguous view of the validation agent 112. In addition to rules governing the operation of the validation agent 112, the configuration data of the validation agent 112, may include the vouchers 114 used by the validation agent 112 to validate target software. Those vouchers 114 loaded into memory during execution of the validation agent 112 may thereby be accessed by the validation core 122 when accessing the run-time data image of the validation agent 112.

The MAC Shim 120 allows the validation core 122 to communicate with the network computer 20 via a data link 126. The MAC Shim 120 may further gather statistics on data frames and data packets being sent to and from the client 26 via data link 128. If the validation core 122 determines that the target routine (e.g., the validation agent 112) has been compromised, the validation core 122 may generate an alert to the network computer 20 and instruct the MAC Shim 120 to restrict the client's access to and from the network 22. Likewise, if the validation agent 112 determines that the target routine (e.g., the security tool 106) has been compromised, the validation agent 112 may generate an alert to the network computer 20 and instruct the MAC Shim 120 to restrict the client's access to and from the network 22. The compromised client 26 is therefore unable to cause further damage to other systems or clients 34 on the network 22.

The data packet statistics gathered by the MAC Shim may be used to further validate target routine (e.g., the security tool 106). For example, a voucher 114, or other source, may contain statistics on data packets sent to and from the firewall 106. All network traffic to and from the client 26 is intended to be routed through the firewall 106. The MAC Shim 120 may monitor the network traffic through the network interface controller 28 and compare the network traffic statistics to the statistics of the firewall 106 to ensure that all network traffic is routed through the firewall 106. A mismatch may be indicative of someone attempting to circumvent the security tool 106.

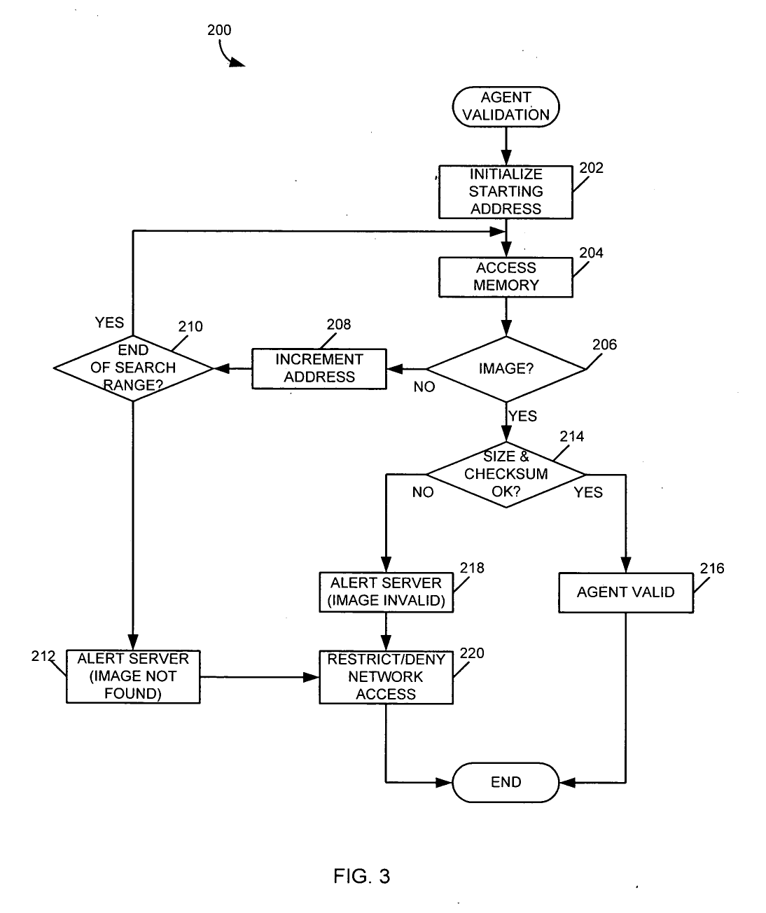

FIG. 3 is a flowchart of an example of a routine 200 that may be utilized by the validation core 122 to monitor and validate a run-time code image of the validation agent 112. By monitoring and validating a run-time image of the validation agent 112 being validated, the integrity of the validation agent 112 may be verified, and the validation core 122 may detect network attacks and unauthorized access as the validation agent 112 is being executed. Those of ordinary skill in the art will likewise recognize that the routine 200 may be modified to monitor and validate forms of software other than the validation agent 112. Although the following routine 200 will be described with reference to validation of a run-time code image of the target routine, those of ordinary skill in the art will recognize that the routine 300 may likewise be used to validate the target routine using data images, network traffic statistics, or other characteristics of the target routine. The routine 200 may be executed periodically to ensure the ongoing health of the validation agent 112, or may be triggered by a combination of various conditions and events such as a fixed time interval, the number of packets transmitted through the network interface controller 28, a request by the network computer 20, etc.

Referring to FIG. 3, the routine 200 may begin at block 202 where the validation core 122 may initialize a starting address of a memory of the client 26 in order to begin searching for a run-time code image of the validation agent 112 to monitor and validate the validation agent 112. At block 204, the routine 200 may access and copy a portion of the physical memory of the client 26 via direct memory access from the processors of the network interface controller 28.

The routine 200 may determine whether a code image of the validation agent 112 has been located at block 206. Alternatively or in combination, the routine 200 may determine whether network traffic statistics, a data image (e.g., validation agent 112 configuration data) and/or other characteristics of the target routine have been located at the memory address. The particular software characteristic being validated may depend on the desired security review (e.g., code integrity, configuration manipulation, etc.). If the code image is not found at the address being searched, the routine 200 may increment the memory address at block 208 to continue searching for the code image. If there are additional memory addresses to search, as determined at block 210, the routine 200 may return control to block 204 to access the memory of the client 26 at a new memory address. If the routine 200 determines at block 210 that no further memory addresses are available to search, the routine 200 may alert the network computer 20 that a code image was not found at block 212.

If the routine 200 determines that a code image has been located at block 206, the routine 200 may validate the code image at block 214. The code image may be validated by comparing the size of the code image as compared to the size of an uncompromised version of the executable code for the validation agent 112. Cryptographic hash functions requiring a secret key may also be used and verified by comparing the hash result, because an attacker will generally not know how to reformat the code to impersonate the hash result without knowing the key. Additional or alternative characteristics may be compared depending on the particular software characteristic, such as a digital watermark, digital signature, checksum values, etc. If the code image is validated at block 214, the routine 200 may determine that the validation agent 112 is valid and uncompromised at block 216. If the routine 200 determines that the code image is not valid at block 214, the routine 200 may alert the network computer 20 that the code image of the validation agent 112 is invalid at block 218. If the routine 200 determines that a code image was not found at block 212 or that the code image is invalid at block 218, the routine 200 may restrict or deny the client 26 of access to the network 22 by instructing the MAC Shim 120 to restrict or deny the client's access and from the network 22 at block 220. The validation core 122 may thereby monitor and validate a non-paged (i.e., unfragmented and contiguous) view of the validation agent 112 by validating a non-paged code image, configuration image, statistics, etc.

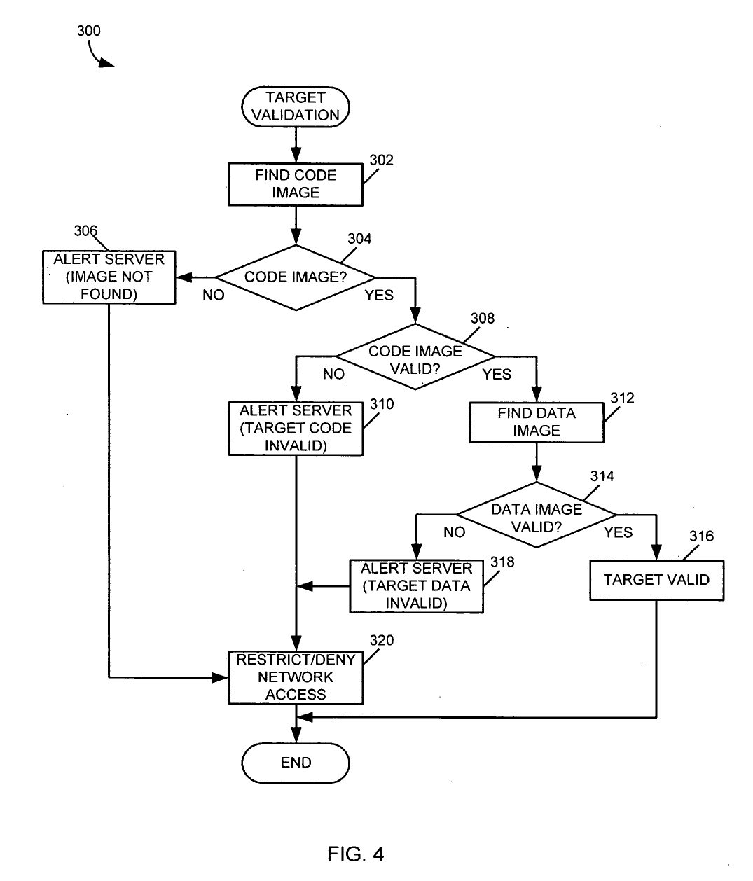

FIG. 4 is an example of a flowchart of a routine 300 which may be executed by the validation agent 112 to monitor and validate a run-time code image of the target routine, such as the security tool 106. By monitoring and validating a run-time image of the target routine, the integrity of the target routine may be verified, and the validation agent 112 may detect network attacks and unauthorized access as the target routine is being executed. Similar to the routine 200, the routine 300 may be executed by the validation agent 112 periodically to ensure the validity and integrity of the target routine. The routine 300 may be triggered by a combination of various conditions and events such as a fixed time interval, the statistics of data packets transmitted through the network interface controller 28, a request by the network computer 20, etc. Although the following routine 300 will be described with reference to validation of a run-time code image of the target routine, those of ordinary skill in the art will recognize that the routine 300 may likewise be used to validate the target routine using network traffic statistics, or other characteristics of the target routine. For example, the routine 300 will be described with reference to validating a run-time data image (e.g., configuration data) of the target routine in addition to the code image. Those of ordinary skill in the art will recognize that the validation process may be dependent on the particular validation agent 112 being utilized.

Referring to FIG. 4, the routine 300 may begin at block 302 where the validation agent 112 may search for and find the code image of the target routine in the virtual memory of the client 26. Those of ordinary skill in the art will recognize that this may be dependent on the particular operating system being utilized by the client 26, such as whether or not the operating system performs paging operations on the target routine. The routine 300 may determine whether or not a code image has been located.

If the code image has not been located, as determined at block 304, the routine 300 may alert the network computer 20 that the code image of the target routine has not been located at block 306. If a code image has been located at block 304, the routine 300 may determine whether the code image is valid at block 306 by comparing characteristics of the code image to the information regarding the comparable characteristic for an uncorrupted version of the target routine code as contained in the voucher 114 for the target routine. The characteristic may include any of the characteristics contained in the voucher 114, including, but not limited to, checksum values, file size, digital watermarks, digital signatures, cryptographic hash functions and result, etc. If the code image is determined to be invalid at block 306, the routine 300 may alert the network computer 20 that the code image of the target routine is invalid at block 308. If the code image is valid, the routine 300 may proceed to locate a run-time data image of the target routine at block 310 to determine if the configuration of the target routine has been compromised. As with the code image, those of ordinary skill in the art will recognize that the location of the data image may be dependent on the operating system being executed by the client 26.

The routine 300 may then determine whether the data image of the target routine is valid at block 312 by comparing characteristics of the data image to information contained in the voucher 114 for the target routine (e.g., checksum value, file size, settings, digital watermarks, digital signatures, cryptographic hash functions and result, etc.). If the data image is valid as determined at block 312, the routine 300 may determine that the target routine is valid and uncompromised at block 314. If the routine 300 determines that the data image is invalid as compared to the information in the voucher 114, the routine 300 may alert the network computer 20 that the data image of the target routine is invalid at block 316.

If the routine 300 has determined that a code image has not been found at block 306, that the code image of the target routine is invalid at block 308 or that the data image of the target routine is invalid at block 316, the routine 300 may restrict or deny the client's access to the network 22 by instructing the MAC Shim 120 to restrict the client's access at block 318.

While the validation agent 112 may provide the integrity and verification capabilities of an intrusion detection system executed by the client 26, the validation agent 112 is, in turn, monitored and verified by the validation core 122, which is executed by a non-host based processor. Because the validation core 122 is executed on a network interface controller 28, or other intelligent device, the validation core 122 is isolated from the operating system of the client 26 and is invisible to a user or any software being executed on the client 26. Any security compromises occurring on the operating system of the client 26, or compromises to the validation agent 112, may not affect the validation core 122. Additionally, because the MAC Shim 120 is located in the network interface controller 28, security breaches may be easily contained within the client 26 to prevent further damage to other systems on the network 22 by restricting or denying access to and from the network 22 and alerting the appropriate entity via the network computer 20. Monitoring and verifying target routine at various levels (e.g., the agent 112 monitoring the integrity of a security tool 106, and the validation core 122 monitoring the integrity of the agent 112) may provide a security system having various levels of hierarchy.

The hierarchical security system may further accommodate various views of memory (physical and virtual), and enable the validation core 122 to monitor and validate the validation agent 112 by viewing the physical memory on the client 26, while the validation agent 112 monitors and validates a target routine by viewing the virtual memory.

Various methods and apparatus have been described herein, which may be implemented as hardware, software or firmware. The methods and apparatus may further be implemented in one or more routines, which may reside on a machine-accessible medium. A machine-accessible medium may include any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

Although certain apparatus and methods constructed with the teachings of the invention have been described herein, the scope of coverage of this patent has not limited thereto. On the contrary, this patent covers all embodiments of the teachings of the invention fairly falling within the scope of the appended claims either literally or under the doctrine of equivalents.

1. A data security system, comprising:
a memory;
a security tool stored within the memory;
a validation agent stored within the memory;
a first processor operatively coupled to the memory, the first processor being programmed to use the security tool to prevent unauthorized access to the memory and programmed to use the validation agent to monitor the integrity of the security tool;
a second processor programmed to directly access the memory and to monitor the integrity of the validation agent; and
a data bus operatively coupled to the first and second processors, the data bus being arranged to allow the second processor to directly access the validation agent.

2. A data security system as described in claim 1,
wherein the first processor is communicatively coupled to a network, and
wherein the second processor is programmed to cause the first processor to communicatively decouple from the network if the validation agent is compromised.

3. A data security system as described in claim 1,
wherein the first processor is communicatively coupled to a network, and
wherein the second processor is programmed to cause the first processor to communicatively decouple from the network if the security tool is compromised.

4. A data security system as described in claim 1, wherein the security tool comprises a firewall.

5. A data security system as described in claim 1, wherein the validation agent comprises an intrusion detection system.

6. A data security system as described in claim 1, wherein the bus is adapted to allow the second processor to access the memory via direct memory access.

7. A data security system as described in claim 1, wherein the first processor is communicatively coupled to a network, the data security system further comprising a characteristic unique to an uncompromised version of the security tool stored within the memory,
wherein the first processor is programmed to cause the validation agent to compare the stored security tool characteristic to a characteristic of a run-time image of the security tool, and
wherein the first processor is programmed to communicatively decouple from the network if the stored security tool characteristic does not match the run-time security tool characteristic.

8. A data security system as described in claim 1, wherein the first processor is communicatively coupled to a network, the data security system further comprising a characteristic unique to an uncompromised version of the validation agent stored within the memory,
wherein the second processor is programmed to compare the stored validation agent characteristic to a characteristic of a run-time image of the validation agent, and
wherein the second processor is programmed to communicatively decouple the first processor from the network if the stored validation agent characteristic does not match the run-time validation agent characteristic.

9. A data security system as described in claim 8, wherein the run-time image comprises a run-time code image of the validation agent.

10. A data security system as described in claim 8, wherein the run-time image comprises a run-time data image of the validation agent.

11. A data security system as described in claim 1, wherein a network interface controller comprises the second processor.

12. A data security system as described in claim 1, wherein a local area network on motherboard (LOM) comprises the second processor.

13. A data security system as described in claim 1, wherein a system chipset comprises the second processor.

14. A data security system as described in claim 1, wherein the second processor is communicatively coupled to a server comprising a third processor,
the third processor being programmed to receive data relating to the security tool,
the third processor being programmed to determine a characteristic unique to an uncompromised version of the security tool from the data relating to security tool,
the third processor being programmed to send the security tool characteristic to the memory.

15. A data security system as described in claim 1, wherein the second processor is communicatively coupled to a server comprising a third processor, wherein the second processor is programmed to cause the server to be alerted of a security breach if the first processor is communicatively decoupled from a network.

16. A data security system as described in claim 1,
wherein the first processor is programmed to maintain an unfragmented and contiguous view of the security tool in a virtual memory; and
wherein the first processor is programmed to provide the validation agent with access to the virtual memory to view the security tool.

17. A data security system as described in claim 1,
wherein the first processor is programmed to maintain an unfragmented and contiguous view of the validation agent in a physical memory; and
wherein the second processor is programmed to access the physical memory to view the validation agent.

18. A method of monitoring the integrity of security components comprising:
causing a first processor to execute a validation agent to compare a characteristic of an uncompromised version of a security tool stored in a memory to a characteristic of a run-time image of the security tool;
causing a second processor to compare a characteristic of an uncompromised version of the validation agent stored in the memory to a characteristic of a run-time image of the validation agent;
communicatively decoupling the first processor from a network if the stored security tool characteristic does not match the run-time security tool characteristic; and
communicatively decoupling the first processor from the network if the stored validation agent characteristic does not match the run-time validation agent characteristic.

19. A method of monitoring the integrity of security components as described in claim 18, wherein causing the first processor to execute the validation agent to compare a characteristic of an uncompromised version of the security tool to a characteristic of a run-time image of the security tool comprises causing the first processor to execute the validation agent to compare a characteristic of an uncompromised version of the security tool to a characteristic of a run-time code image of the security tool.

20. A method of monitoring the integrity of security components as described in claim 18, wherein causing the first processor to execute the validation agent to compare a characteristic of an uncompromised version of a security tool to a characteristic of a run-time image of the security tool comprises causing the first processor to execute the validation agent to compare a characteristic of an uncompromised version of a security tool to a characteristic of a run-time data image of the security tool.

21. A method of monitoring the integrity of security components as described in claim 18, wherein causing the second processor to compare a characteristic of an uncompromised version of the validation agent to a characteristic of a run-time image of the validation agent comprises causing the first processor to compare a characteristic of an uncompromised version of the validation agent to a characteristic of a run-time code image of the validation agent.

22. A method of monitoring the integrity of security components as described in claim 18, wherein causing the second processor to compare a characteristic of an uncompromised version of the validation agent to a characteristic of a run-time image of the validation agent comprises causing the first processor to compare a characteristic of an uncompromised version of the validation agent to a characteristic of a run-time data image of the validation agent.

23. A method of monitoring the integrity of a security component as described in claim 18, further comprising:
causing the second processor to directly access the memory; and
retrieving the stored validation agent characteristic and the run-time validation agent characteristic from the memory.

24. A method of monitoring the integrity of security components as described in claim 18, further comprising:
transmitting data relating to information regarding an uncompromised version the security tool to a remote network computer operatively coupled to the network;
receiving voucher data from the remote network computer, the voucher data relating to the security tool characteristics developed from the data relating to the information regarding an uncompromised version of the security tool; and
storing the data relating to the security tool characteristics in the memory.

25. A method of monitoring the integrity of security components as described in claim 18, further comprising alerting a remote network computer of a security breach if the first processor is communicatively decoupled from a network.

26. A method of monitoring the integrity of security components as described in claim 18 further comprising:
causing the first processor to maintain an unfragmented and contiguous view of the security tool ins a virtual memory; and
causing the first processor to provide the validation agent with access to the virtual memory to view the security tool.

27. A method of monitoring the integrity of security components as described in claim 18 further comprising
causing the first processor to maintain an unfragmented and contiguous view of the validation agent in a physical memory; and
causing the second processor to access the physical memory to view the validation agent.

28. An article of manufacture comprising:
a computer readable memory;
a first routine stored on the computer readable memory and adapted to be executed on a first processor operatively coupled to a bus to monitor the integrity of a security tool adapted to be executed on the first processor,
a second routine stored on the computer readable memory and adapted to be executed on a second processor operatively coupled to the bus to monitor the integrity of the first routine; and
a third routine stored on the computer readable memory and adapted to be executed by the second processor to communicatively decouple the first processor from a network if the second routine determines the first routine has been compromised.

29. An article of manufacture as described in claim 28, further comprising a fourth routine stored on the computer readable medium and adapted to be executed on the second processor to communicatively decouple the first processor from a network if the first routine determines the security tool has been compromised.

30. An article of manufacture as described in claim 29, further comprising a fourth routine stored on the computer readable medium and adapted to be executed on the second processor to alert a remote network computer of a security breach if the first processor is communicatively decoupled from the network.

31. An article of manufacture as described in claim 28, wherein the first routine is adapted to be executed on the first processor to compare a characteristic unique to an uncompromised version of the security tool to a characteristic of a run-time image of the security tool.

32. An article of manufacture as described in claim 28, wherein the second routine is adapted to be executed on the second processor to compare a characteristic unique to an uncompromised version of the first routine to a characteristic of a run-time image of the first routine.

33. An article of manufacture as described in claim 28, further comprises:
a fourth routine stored on the computer readable medium and adapted to be executed on the first processor to transmit data relating to information regarding an uncompromised version of the security tool to a remote network computer;
a fifth routine stored on the computer readable medium and adapted to be executed on the first processor to receive voucher data from the remote network computer, the voucher data relating to characteristics unique to the uncompromised version of the security tool developed from the data relating to the information regarding an uncompromised version of the security tool; and
a sixth routine stored on the computer readable medium and adapted to be executed on the first processor to store the security tool characteristics.

34. An article of manufacture as described in claim 28, wherein the security tool comprises a firewall.

35. An article of manufacture as described in claim 28 wherein the second and third routines are adapted to be executed on a processor of a network interface controller.

36. An article of manufacture as described-in claim 28, wherein the second and third routines are adapted to be executed on a processor of a local area network on motherboard (LOM).

37. An article of manufacture as described in claim 28, wherein the second and third routines are adapted to be executed on a processor of a system chipset.

38. An article of manufacture as described in claim 28, further comprising:
a fourth routine stored on the computer readable medium and adapted to be executed on the first processor to maintain an unfragmented and contiguous view of the security tool in a virtual memory; and
a fifth routine stored on the computer readable medium and adapted to be executed on the first processor to provide the validation agent with access to the virtual memory to view the security tool.

39. An article of manufacture as described in claim 28, further comprising:
a fourth routine stored on the computer readable medium and adapted to be executed on the first processor to maintain an unfragmented and contiguous view of the validation agent in a physical memory; and
a fifth routine stored on the computer readable medium and adapted to be executed on the second processor to access the physical memory to view the validation agent.
